(19) United States
(12) Patent Application Publication
(10) Pub. No.: US 2026/0366907 A1
(43) Pub. Date: Nov. 19, 2026

(54) VEHICLE INCLUDING A LOAD DETECTION ARRANGEMENT

(71) Applicant: ROBERT BOSCH LIMITADA, Campinas-SP (BR)

(72) Inventor: Alvaro Augusto VASCONCELOS, Campinas-SP (BR)

(73) Assignee: ROBERT BOSCH LIMITADA, Campinas-SP (BR)

(21) Appl. No.: 19/137,116

(22) PCT Filed: Dec. 20, 2023
(86) PCT No.: PCT/BR2023/050463

§ 371 Date: Jun. 9, 2025

(30) Foreign Application Priority Data
Dec. 21, 2022 (BR) 102022026193-8

(51) Int. Cl. G01G 19/08; G01G 3/15; G01G 19/02

(52) U.S. Cl. CPC G01G 19/08; G01G 3/15; G01G 19/022

(57) ABSTRACT

The present invention refers to a vehicle (100) including a load detection arrangement that includes at least one load sensor (10) which, according to a first embodiment, is associated with at least one axle (20) of the vehicle, whereby: said at least one load sensor (10) is housed inside said at least one axle (20); said at least one load sensor (10) is arranged at the end of said at least one axle (20), in a region that supports at least one respective wheel (30) of the vehicle; whereas, according to a second embodiment, it is associated with at least one structural longitudinal rail (50) of the vehicle (100); the combination of the two embodiments is also envisaged.

### FIELD OF INVENTION

The present invention refers to transport vehicles and, more specifically, to vehicles that include load detection arrangements.

### BACKGROUND OF THE INVENTION

Measuring a load (or, in other words, weight) of a vehicle is mainly carried out on large vehicles, such as trucks, semi-trailers and trailers, for the purpose of preventing traffic accidents, such as rollover due to overload and, also, to avoid the deterioration of the vehicle itself, as well as the surfaces, streets and highways on which it travels, for example.

Therefore, in Brazil, for example, weighing platforms installed marginally to highways are quite common. However, once this conventional load measurement requires a large installation space, the costs involved are very high.

In order to avoid this drawback, the state of the art already provides for some solutions in which the load measurement is embedded in the vehicles themselves.

Documents U.S. Pat. No. 5,681,998, CN208751691, U.S. Pat. No. 4,728,922, DE3711175, U.S. Pat. No. 5,811,738, U.S. Pat. No. 5,410,109, JP9133571, for example, already disclose, each with its own particularity, different load detection arrangements, embedded in vehicles, in which the set or sensor element is directly associated with the flat springs of the vehicle's suspension. This type of arrangement carries a huge drawback, since the flat spring beam has a non-uniform behavior due to constructive differences (geometry, for example) and even mechanical properties between each of the springs (different heat treatment, for example) and even due to the friction between them.

In other words, and still in this context of dynamic weighing, when this spring beam is loaded, the springs are in a certain situation and, consequently, a load sensor associated with them would result in a first measurement. When the spring beam is unloaded, due to the aspects mentioned above, there is a huge possibility that this spring beam will not return to its initial state, which would result in a residual value with the load sensor, causing uncertainties in the measurements. In this sense, even the acceleration and braking of the vehicle can cause these measurement errors.

On the other hand, other patent documents, now considered more relevant, already provide for arrangements that detach load sensors from flat springs, such as EP0307634, US2005081649, EP3795959, US2021008940 and U.S. Pat. No. 6,084,183. More specifically, the solutions in these documents envisage associating these sensors with the axles of vehicles, each in its own way.

The solution of documents EP0307634, US2005081649, EP3795959, US2021008940 and U.S. Pat. No. 6,084,183, however, provides for the placement of the sensor on the outside of the axle, which poses some risks related to their protection against mechanical damage and/or bad weather, such as temperature, water, wind, dust, etc.

In addition, except for US2021008940, none of the documents EP0307634, US2005081649, EP3795959, and U.S. Pat. No. 6,084,183 provides for an arrangement of said sensor that would allow a possible retrofit of previously designed vehicle axles.

Thus, and although the solutions described above are functional for the purposes for which they were made possible, it is noted that there are still gaps in the state of the art with regard to the provision of a load detection arrangement for vehicles, by means of a solution sufficiently robust, resistant, efficient, easy to assemble, reliable and that allows the retrofit of an axle of a previously designed vehicle.

It is based on this scenario that the present invention arises.

### OBJECTIVES OF THE INVENTION

Thus, it is a fundamental objective of the invention in question to disclose a vehicle including a load detection arrangement;

More specifically, the objective of the present invention is to describe a sufficiently robust, resistant, easy to assemble solution and protected from mechanical damage and/or weathering, for a load detection arrangement in a vehicle;

In addition, it is an objective of this invention to provide a load detection arrangement that provides more reliable and efficient measurements, depending on the specific arrangement of the sensor.

### SUMMARY OF THE INVENTION

According to a first embodiment, the objectives summarized above are achieved by means of a vehicle including a load detection arrangement, of the type that includes at least one load sensor, where: said at least one load sensor is housed inside said at least one axle; said at least one load sensor is arranged at the end of said at least one axle, in a region that supports at least one respective wheel of the vehicle.

Alternatively, according to a second embodiment, the above objectives are achieved by means of a vehicle including a load detection arrangement, of the type that includes at least one load sensor, whereby said arrangement includes at least one load sensor associated with at least one structural longitudinal rail of the vehicle.

Preferably, said at least one load sensor is housed inside a respective envelope body that is attachable to said at least one axle, so as to integrate with it.

Also preferably, said envelope body is coaxially attachable to the respective axle, at its end, in order to define an extension of the latter. Also preferably, said envelope body comprises a shape substantially analogous to the shape of the hub of the respective wheel in order to enable cooperation between both.

It is also preferable that this arrangement includes at least one load sensor associated with each of the wheels. Further, the use of a magnetic type load sensor is preferred.

Optionally, according to the first embodiment of this invention, said arrangement also includes at least one other load sensor associated with at least one structural longitudinal rail of the vehicle.

Finally, it should be noted that this invention is applicable to both motor and powered vehicles.

### BRIEF DESCRIPTION OF THE DRAWINGS

The invention in question is now explained in detail based on the illustrative figures listed below:

FIG. 1 illustrates a posterior perspective view of a type of vehicle in which the load detection arrangement of the present invention is capable of being applied;

FIG. 2 illustrates a view of detail A of FIG. 1, with the omission of the respective wheel, for a better visualization of the components, according to the first embodiment of this invention;

FIG. 3 illustrates the same view as FIG. 2, but with a transparent envelope for better visualization of its internal aspect;

FIG. 4 illustrates an exploded view of the envelope body and load-sensing pair, according to the first embodiment of the present invention.

FIG. 5 illustrates a view of detail B of FIG. 1, according to the second embodiment of the present invention and/or according to the optional version of the first embodiment.

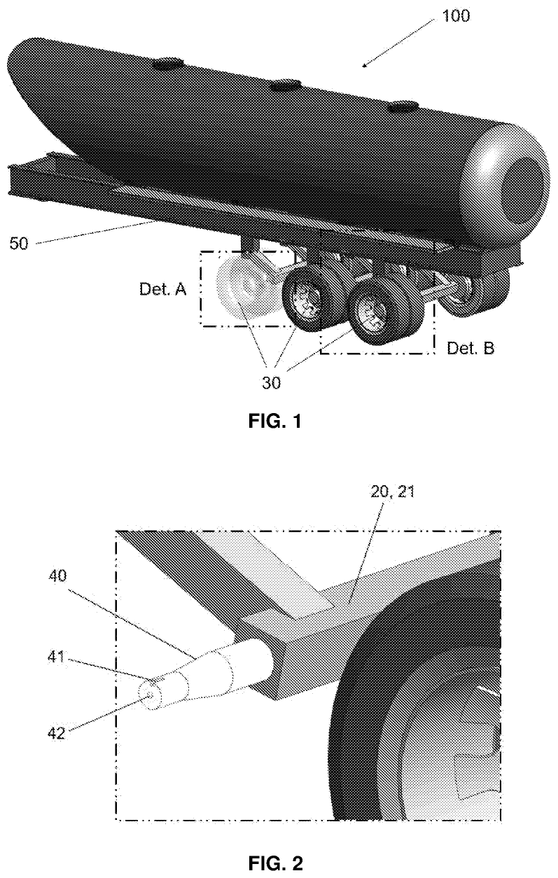

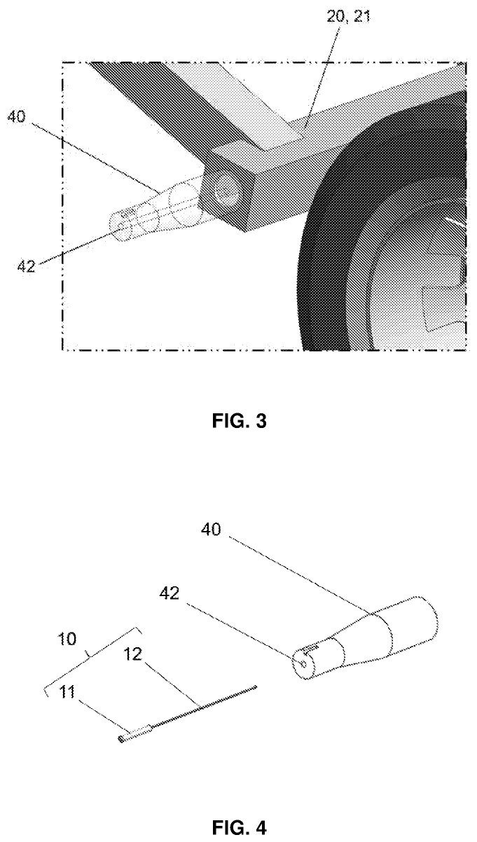

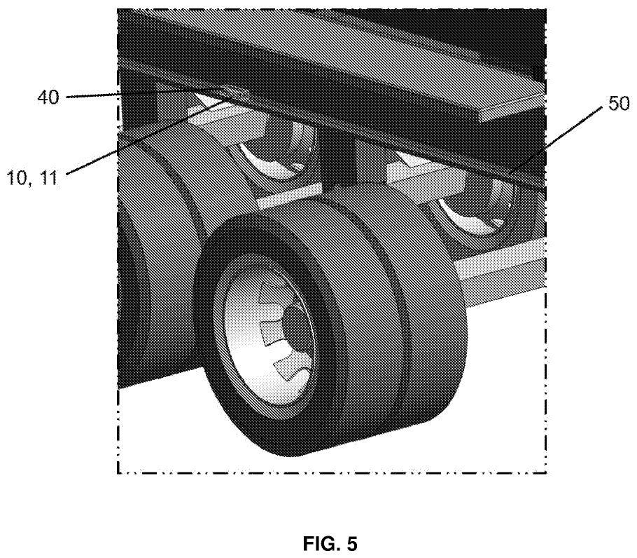

### DETAILED DESCRIPTION OF THE INVENTION

Thus, with a focus on achieving the aforementioned objectives, in a first possible embodiment, the present invention concerns a vehicle 100 including a load detection arrangement, of the type that includes at least one load sensor 10 associated with at least one axle 20 of the vehicle, said at least one load sensor 10 being housed inside said at least one axle 20.

The main reason for this provision is to detach the load measurement of the suspension (flat springs) from the vehicle 100, and perform it next to a part of the vehicle 100 that allows dynamic weighing, reflecting greater precision/assertiveness. Another reason for this arrangement is the protection of the load sensor itself 10 against mechanical damage and/or bad weather, such as rain, thermal oscillation, wind, dust, etc.

Here it is worth noting that, when mentioning load sensor 10, the entire sensor set must be understood, which includes the sensitive element 11, its envelope cover and/or eventual wireless module or other elements, as the case may be, except for any electrical wiring 12 that need to extend outside this region for reasons of electrical connection, obviously.

Further, said at least one load sensor 10 is arranged at the end of said at least one axle 20, in a region that cooperates with at least one respective wheel 30 of the vehicle. In this sense, it should be noted that it is possible to provide a load sensor 10 associated with each respective wheel of the vehicle 30, in order to have an individualized measurement—and therefore more accurate—for each wheel 30.

This means that said load sensor 10 is circumferentially surrounded by the wheel 30 of the vehicle. More specifically, this region of the axle 20 supports, that is, rotatably bears the hub of the respective wheel 30 of the vehicle.

Preferably, said at least one load sensor 10 is housed inside a respective envelope body 40 which is attachable (preferably, welded) to the respective end of a main part 21 of said at least one axle 20, so as to integrate into it. In this case, it should be understood that the combination between envelope body(ies) 40 and main part 21 define the 20 axle, as a whole. According to this embodiment, the envelope body 40 rotatively supports/bears the wheel hub 30. In other words, said envelope body 40 is the axle end 20.

In this case, it would be preferable that said envelope body 40 be coaxially attachable to the respective axle 20, as an extension of it and, more specifically, as an extension of the main part 21.

In other words, the axle 20 can be one-piece and house the load sensor 10 inside it, in at least one of its distal portions or, alternatively, said axle 20 can be bipartite (or tripartite, for example), formed by the main part 21 and by envelope body(s) 40 to be associated with the distal portion(s) of the main part 21, and respective load sensors 10, in this case, would be housed inside the respective enveloping bodies 40, as mentioned above.

Said envelope body 40 defines a hollow region 42 that is able to receive and house said load sensor 10, preferably in a juxtaposed manner, as illustrated in FIG. 2. In other words, it is preferable that the portion related to the sensitive element 11 of the load sensor 10 be fitted tightly together with at least one portion of the hollow region 42, in order to facilitate the transfer of mechanical forces from one body to the other and, consequently, to enable the measurement of load in an accurate manner. The load sensor 10 can still be threaded next to the hollow region 42 of the envelope body 40.

Also, according to this first embodiment, said envelope body 40 comprises a cooperating format with the wheel hub 30 of the vehicle, as well as a fitting means 41 to ensure adequate coupling with said wheel hub 30.

Such a shape could be substantially conical trunk or like two cylinders joined by a cone trunk, as illustrated in the figures, for example. In summary, the shape of the envelope body 40 must be substantially analogous to that of the wheel hub 30, in order to enable cooperation between the two.

This preferred arrangement is particularly advantageous because it allows said envelope body 40 to be coupled to an axle 20 (or fixed part 21) previously designed, thus enabling the retrofit thereof.

Also according to this first embodiment presented, the invention in question enables precise monitoring even for the control of effort on the axle 20 (as a whole, that is, envelope body 40 and main part 21) and the loss of connection/electrical signal between the sensitive element 11 and the module (processing/control—not illustrated) to which it is connected can be interpreted as the rupture of the electrical wiring 12 and, consequently, by the separation/rupture of the envelope body 40 in relation to the main part 21 of the axle 20. That is, the load sensor 10 can also be used as an integrity sensor of the axle 20 and/or envelope body 40.

Optionally, said load detection arrangement may also include at least one other load sensor 10 associated with at least one structural longitudinal rail 50 of the vehicle 100. The inherent advantage of this optional configuration is related to obtaining a greater amount of measurement data and the possibility of comparing the data from the different load sensors 10. In addition, the mounting of load sensors 10 on 100 previously designed vehicles next to the respective structural longitudinal rails 50 is facilitated, without major layout changes of the vehicle 100 in question, allowing retrofit, for example.

In a second embodiment of the invention, said load detection arrangement may include at least one load sensor 10 associated with at least one structural longitudinal rail 50 of the vehicle 100, independent of the provision of load sensors 10 next to the wheels 30 of the vehicle 100.

The main reason for this second embodiment, as well as the first embodiment, is to detach the suspension load measurement (flat springs) from the vehicle 100, and perform it next to a part of the vehicle 100 that reflects greater precision/assertiveness. On the other hand, unlike the first embodiment exposed, this second embodiment would not carry as many advantages as the protection of the load sensor 10 against mechanical damage and/or bad weather, such as rain, thermal oscillation, wind, dust, etc.

To this end, said load sensor 10 is housed inside an envelope body 40 which, in turn, is coupled and fixed to the vehicle's structural longitudinal rail(s) 100. It should be noted that this second embodiment would also make retrofit possible.

As in the first embodiment, in this second embodiment, said envelope body 40 also defines a hollow region 42 that is able to receive and house said load sensor 10, preferably in a juxtaposed manner. In other words, it is preferable that the portion related to the sensitive element 11 of the load sensor 10 be fitted tightly together with at least one portion of the hollow region 42, in order to facilitate the transfer of mechanical forces from one body to the other and, consequently, to enable the measurement of load in an accurate manner.

The load sensor 10 can still be threaded in the hollow region 42 of the envelope body 40.

According to this second embodiment, the outer shape of the envelope body 40 is not especially relevant, but just to mention one possibility, such a shape could be parallelepiped.

In any of the above arrangements, it is preferable that such load sensor 10 be of the magnetic type. This allows the load sensor 10 to be installed next to the referred axle 20 and/or structural longitudinal rail(s) 50—or next to the envelope body 40—in any orientation, which makes the arrangement now proposed feasible and also facilitates the manufacture of the set.

Furthermore, in both of the above embodiments, it is preferable that the envelope body 40 be designed and dimensioned in such a way as to be only elastically (and not plastically) deformable, when subjected to mechanical stresses, so that when unloaded, it does not retain any residual load that could be transmitted to the load sensor 10 and end up causing measurement errors.

Thus, depending on the provisions presented and the type of load sensor 10 being of the magnetic type, a more accurate measurement of the vehicle load 100 is achieved. This is because the magnetic sensor detects the displacement of the load in all directions, unlike a load cell, for example, which would detect the load in only one direction.

It should be noted that the aforementioned load detection arrangements, in any of the above embodiments, can be applied to a motor vehicle or a powered vehicle, such as a truck or a trailer, respectively.

It is important to emphasize that the sole objective of the above description is to describe in an exemplifying way the particular embodiment of the invention in question. Therefore, it becomes clear that modifications, variations and constructive combinations of the elements that perform the same function in substantially the same way to achieve the same results, continue within the scope of protection delimited by the accompanying claims.

1. A vehicle including a load detection arrangement, of a kind that includes at least one load sensor, wherein:
the at least one load sensor is housed inside at least one axle of the vehicle;
the at least one load sensor is arranged at the end of the at least one axle, in a region that supports at least one respective wheel of the vehicle.

2. A vehicle including a load detection arrangement, of a type that includes at least one load sensor, wherein the load detection arrangement includes at least one load sensor associated with at least one structural longitudinal rail of the vehicle.

3. The vehicle including a load detection arrangement, according to claim 1, wherein the at least one load sensor is housed within a respective envelope body which is attachable to at least one axle, so as to integrate with it.

4. The vehicle including a load detection arrangement, according to claim 3, wherein the envelope body is coaxially attachable to the respective axle, at its end, so as to define an extension of the latter.

5. The vehicle including a load detection arrangement, according to claim 3, wherein the envelope body comprises a shape substantially analogous to the shape of the hub of the respective wheel in order to enable cooperation between both.

6. The vehicle including a load detection arrangement, according to claim 1, wherein it comprises at least one load sensor associated with each of the wheels.

7. The vehicle including a load detection arrangement, according to claim 1, wherein the load detection arrangement also includes at least one other load sensor associated with at least one structural longitudinal rail of the vehicle.

8. The vehicle including a load detection arrangement, according to claim 1, wherein the load sensor is magnetic.

9. The vehicle including a load detection arrangement, according to claim 1, wherein the vehicle is of the engine type.

10. The vehicle including a load detection arrangement, according to claim 1, wherein vehicle is of the powered type.
